(19) United States
(12) Patent Application Publication
(10) Pub. No.: US 2008/0120634 A1
(43) Pub. Date: May 22, 2008

(54) Limited life medium

(75) Inventor: Patrick Larroche, New York, NY (US)

Correspondence Address: Henry Blanco White, Esq.;Drinker Biddle & Reath LLP, One Logan Square, 18th and Cherry Streets, Philadelpha, PA, 19103-6996, US

(73) Assignee: FDD Technologies sa/ag/ltd, Zug (CH)

(21) Appl. No.: 11/985,179

(22) Filed: Nov. 13, 2007

Related U.S. Application Data
(60) Provisional application No. 60/860,567, filed on Nov. 21, 2006.
(60) Provisional application No. 60/860,615, filed on Nov. 22, 2006.
(60) Provisional application No. 60/860,553, filed on Nov. 22, 2006.

(51) Int. Cl. G11B 7/24; G11B 23/03

(52) U.S. Cl. 720/718

(57) ABSTRACT

A limited-life storage medium comprises a flowable agent. The flowable agent comprises water and a hygroscopic substance. In one example, the flowable agent is a mixture of glycol and water with an acid or other corrosive active ingredient dissolved in it. In one example, the storage medium is an optical disc. When the disc is read, the rotation of the disc propels the flowable agent into contact with a metal data-carrying layer. In one example, the hygroscopic substance reduces any tendency of the flowable agent to dry out and cease to be flowable, and may tend to buffer the proportion of water in the flowable medium within a range.

### CROSS-REFERENCE TO RELATED APPLICATIONS

This application claims the benefit of my U.S. Provisional Patent Application No. 60/860,567, titled Limited Life Medium, filed Nov. 21, 2006, which is incorporated herein by reference in its entirety.

The present application is related to my co-pending U.S. Patent Application No. 60/860,615, titled Limited Installation Medium, filed Nov. 22, 2006, and U.S. Patent Application No. 60/860,553, titled Limited Life Medium, Nov. 22, 2006, which are incorporated herein by reference in their entirety, and to commonly invented and assigned U.S. Patent Application Publication No. 2005/0195728, which is incorporated herein by reference in its entirety.

### FIELD OF THE INVENTION

The invention relates to media used to distribute information, and especially to such a medium that is intended to become unusable within a short period after the medium is first used or activated.

### BACKGROUND

It is well known to distribute information, for example, music or motion pictures, on a disc or other portable medium. The medium may be either rented or sold to a member of the public who wishes to listen to or view the content of the medium. Sale prices are higher than rental fees, because a purchaser who retains possession of a copy of the content permanently gains greater benefit than a renter who has the medium with the content for only a short time. In order to prevent users from improperly exploiting the price difference, rental stores take steps to ensure that copies of the medium are returned at the end of the rental period. However, these returns are expensive for the store and inconvenient for the customer.

In order to eliminate the administrative cost and inconvenience of rental returns, it has previously been proposed to provide a storage medium that becomes unusable within a short period after the medium is removed from its packaging or after the medium is first read. For rental of motion pictures, a period of a few hours to a few days is typically appropriate.

Examples of previously-proposed limited life media are described in commonly invented U.S. Pat. No. 6,468,619, and U.S. Patent Application Publication No. 2005/0195728, and in U.S. Pat. No. 6,100,772.

With all of these devices, either reading the storage medium or some step preliminary to such reading, such as removing the storage medium from a container, initiates a process that renders the storage medium unusable. In many of these previously proposed devices, the agent that limits the life of the medium is a liquid, such as a solution of a mild acid or other corrosive agent in water, and the process of rendering the medium unusable is initiated by moving the solution from a storage location within the medium to an active location at which the liquid is in contact with a part of the storage medium that actually carries data.

U.S. Patent Application Publication No. 2005/0195728 proposes an optical disc that self-destructs within a predetermined period after the disc is first read. The disc described in U.S. Patent Application Publication No. 2005/0195728 contains a reservoir of solvent near its center. The process of reading the disc involves rotating the disc at high speed. Centrifugal and other forces from the rotation redistribute the solvent to a location where the solvent destroys part of the data storage layer. The disc of U.S. Patent Application Publication No. 2005/0195728 is well suited to discs of the CD or DVD type, in which the data storage layer is a thin metal foil, susceptible to destruction by mild acids, and in which the inner edge of the data storage layer carries a vital control track. By suitable selection of the strength of the acid, the time within which the disc becomes unusable can be selected in a range from minutes to days.

In the interests of economy and reliability, a simple design of the mechanism for moving the solution to the active location is desirable. The mechanism of U.S. Patent Application Publication No. 2005/0195728 is especially simple. That mechanism has no moving parts, and is operated solely by the liquid flowing under the action of centrifugal and other forces resulting from the rotation of the disc. However, where a flowing liquid is used, the fluid properties of the liquid, such as viscosity and surface tension, are significant. It is well within the ordinary skill in the art to formulate suitable liquid agents by adjusting the composition of the liquid and the dimensions of the chambers and passages within which the liquid is contained.

The polycarbonate material from which commercially-available optical discs are commonly made is not totally impervious to water vapor. It has now been found that under usual conditions the water in the active liquid of previously proposed limited life media can evaporate through the polycarbonate at a sufficient rate that an appreciable proportion of the water in the active liquid evaporates during the shelf-life of the media. In normal conditions, the liquid can dry up, and cease to be effective, so that the medium ceases to be a limited life medium within a period of from one to three months. In less extreme cases, the loss of water results in a smaller volume of more concentrated liquid, with a different viscosity and/or surface tension, that flows differently. The change in properties may affect the reliability of the life-limiting action.

There is therefore a continuing need for an improved optical disc or other storage medium that more reliably retains its limited-life properties in storage.

### SUMMARY

The present invention provides a limited-life data storage medium, comprising a flowable agent, wherein the flowable agent comprises water and a hygroscopic substance.

Where the hygroscopic substance is flowable, the hygroscopic substance may comprise a substantial proportion of the flowable agent.

The hygroscopic substance may comprise glycol. The glycol may comprise propan-1,2-diol.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic drawing of an optical disc.

FIG. 2 is a block diagram of a system for playing video discs.

FIG. 3 is a flowchart.

### DETAILED DESCRIPTION

Reference will now be made in detail to various embodiments of the present invention, examples of which are illustrated in the accompanying drawings.

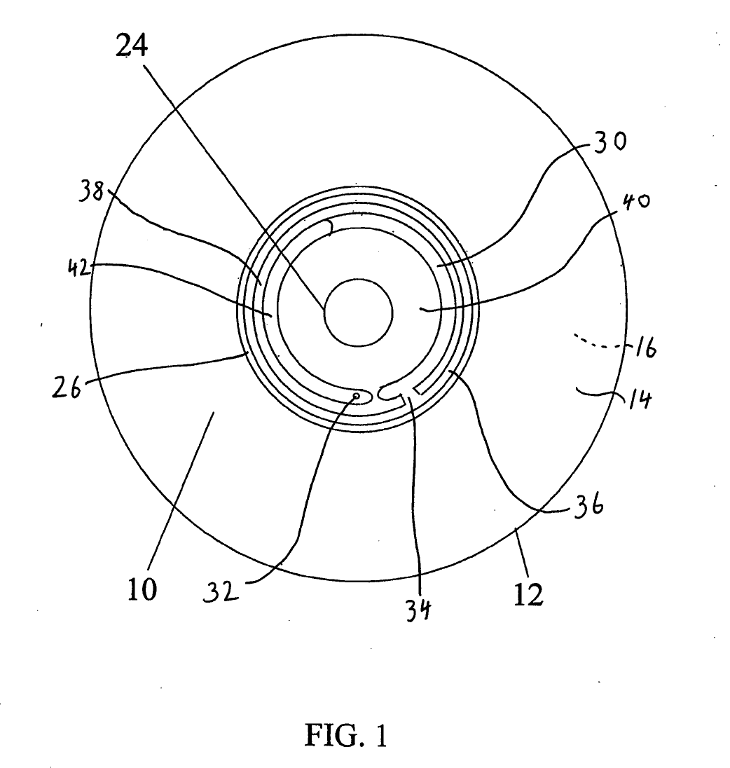

Referring initially to FIG. 1, one embodiment of a storage medium, indicated generally by the reference numeral 10, is in the form of an optical disc, which may be generally similar to the disc 10 shown in U.S. Patent Application Publication No. 2005/0195728. The disc 10 is circular, and has an outer periphery 12.

The optical storage medium 10 is a laminate that consists essentially of, in order, a first rigid substrate 14, a first layer of reflective material 16, a layer of adhesive, and a second rigid substrate (not shown) which except as discussed below may be substantially the same as the first rigid substrate 14. A second layer of reflective material (not shown) which except as discussed below may be substantially the same as the first layer of reflective material 16, and/or a decorative layer or a layer bearing human-readable indicia, may also be present between the layer of adhesive and the second rigid substrate. The substrates include a central aperture or opening 24 and are made of transparent material, such as plastic, for example, transparent polycarbonate plastic. Polycarbonate is presently preferred, because it is commonly used for commercially-available CDs and DVDs, and the processes for forming polycarbonate into the substrate 14 are widely available and well understood.

In the embodiment, the first reflective layer 16 is a metal coating formed on the first rigid substrate, and the second reflective layer, if present, is a metal coating formed on the second rigid substrate. The two halves thus formed are then joined together with a layer of hot-melt glue or other adhesive. In pressed CDs and DVDs, the metal coating forming the reflective layers is commonly aluminum, but may instead by silver, or other metals. In recordable CDs and DVDs, the metal coating is usually silver.

The optical storage medium 10 includes readable data or information represented by pits, bumps, dots, or other markings formed in the first reflective layer 16 and having a reflectivity different from the reflectivity of other markings or of unmarked parts of the first reflective layer. The markings are scanned by a laser through the first rigid substrate to read the data. In the embodiment, the markings are preferably pits or dots molded into the surface of the first substrate before the first substrate is coated with the first reflective layer. Various methods for forming the first rigid substrate and the first reflective layer are known and, in the interests of conciseness, will not be further described here.

The second rigid substrate, with the second reflective layer applied to it as a coating, may be similarly formed. The second reflective layer may be a further data storage layer, read either through the first rigid substrate and the first reflective layer, if the first reflective layer is partly reflective and partly transparent, or through the second rigid layer. Alternatively, the second reflective layer may be merely a dummy layer. If the second reflective layer is not used for data storage, it may be omitted. In accordance with the industry standard for DVDs and CDs, the data stored on the first reflective layer starts with a lead-in section 26 at the radially inner edge of the first reflective layer, nearest to the central aperture 24. This configuration is especially suitable for a DVD-9 format disc, in which the first reflective layer is read from the center outward, and the second reflective layer is then read from the circumference inward.

A first reservoir 30 is formed in the second rigid substrate, or alternatively in the first rigid substrate. The first reservoir is in the form of an annular groove in the inner face of the second rigid substrate, concentric with the disc 10 and extending round a majority of arc of the disc 10, for example, for approximately 350° of arc. The first reservoir or groove 30 is separated from the central aperture 24 of the disc 10 by a land 40. Near one end, the groove 30 is connected with the exterior by a hole 32 passing through the thickness of the second rigid substrate. Near the other end, the groove 30 is connected by a radial passageway 34 to a second reservoir or groove 36. The second reservoir 36 is annular, and is concentric with the disc 10 and is radially outside the first reservoir 30. A wall 38 separates the first reservoir 30 from the second reservoir 36, and is penetrated only by the radial passageway 34.

The second reflective layer has its inner edge at the outer edge of the second reservoir 36. However, the lead-in section 26 of the first reflective layer overlaps, and forms at least part of one wall of, the second reservoir 36. The first reflective layer does not overlap the first reservoir or groove 30. Preferably, the inner edge of the first reflective layer is outside the wall 38. Because the position of the lead-in section 26 is effectively determined by the industry standard for CDs, DVDs, and similar media, this effectively determines the radial position of the second reservoir 36. If the second reflective layer is the second data layer of a DVD-9 disc, the DVD-9 standard tolerates having the inner, lead-out edge of the second data layer a few millimeters further out than usual.

The adhesive is applied by coating the second rigid substrate, and the second reflective layer already laminated onto the second rigid substrate, but not applying any adhesive into or over the recesses forming the reservoirs 30 and 36 and the passageway 34. This ensures that the lead-in section 26 is exposed to the outer reservoir 36, while the inner reservoir 30 is entirely enclosed by polycarbonate and adhesive.

Once the disc 10 has been assembled, a liquid chemical agent 42 is introduced into the first reservoir 30 through the hole 32, which is then sealed. After the liquid 42 is introduced, the hole 32 is then sealed with a drop of adhesive.

In normal storage and handling of the disc 10, the liquid 42 is retained in the part of the first reservoir 30 nearest the hole 32 by surface tension. The amount of liquid introduced is not critical, but it is preferred to approximately half fill the first reservoir 30. This allows a reasonable amount of liquid 42, while leaving a substantial length of dry groove 30, so that even if sudden movements of the disc 10 cause some migration of the liquid 42 it is very unlikely to reach the passageway 34.

However, when the optical storage medium 10 is used, the disc is rotated very rapidly, typically at 1000 rpm, to allow it to be read by a fixed laser. This rapid rotation generates a considerable centrifugal force. Assuming that the first reservoir 30 has a radius of 40 mm, the acceleration experienced by the liquid 42 in the first reservoir is about 218 m/s², or more than 20 times the acceleration due to gravity at the earth's surface. This acceleration drives the liquid 42 to the radially outer edge of the groove 30, and causes it to spread along that edge until it reaches the passageway 34. The liquid 42 then spreads along the outer edge of the second reservoir 36, where it comes into contact with the lead-in section 26 of the data on the first reflective layer 16.

In addition, the starting and/or stopping of the rotation of the disc 10 may involve a significant angular or circumferential acceleration of the disc, and may involve sudden changes in that acceleration. The sudden angular motion of the disc, coupled with the inertia of the liquid 42, may provide an impetus sufficient to propel the liquid circumferentially along the reservoirs 30 and 36, or to assist a movement of the liquid caused by other forces. In addition, vibration of the disc, for example, vibration deliberately caused as described in U.S. Patent Application No. 60/860,553 filed Nov. 22, 2006, may cause or assist the movement of the liquid. Depending on the design of the specific disc and the specific disc drive, any or all forces arising from the motion of the disc, including centrifugal force, angular acceleration, and vibration, may cause or contribute in greater or lesser proportion to the movement of the liquid agent 42.

The liquid 42 in the first reservoir 30 is a preselected chemical agent that will render the lead-in section 26 of the optical storage medium 10 unreadable after a preselected period of time, by dissolving or otherwise reacting with the aluminum first reflective layer and altering its reflectivity so that the laser cannot read the data. In the preferred embodiment, the liquid 42 dissolves away the aluminum layer over a period of a few minutes. It is not necessary to obliterate the data on the first reflective layer entirely. Merely damaging the lead-in section 26 renders the disc 10 unusable in any standard DVD or CD player, because the player relies on information in the lead-in section to identify and locate the data files stored on the main part of the disc.

The disc shown in FIG. 1 may be substantially the same as the disc shown and described in U.S. Patent Application Publication No. 2005/0195728 and in the interests of conciseness that description is not here repeated in full.

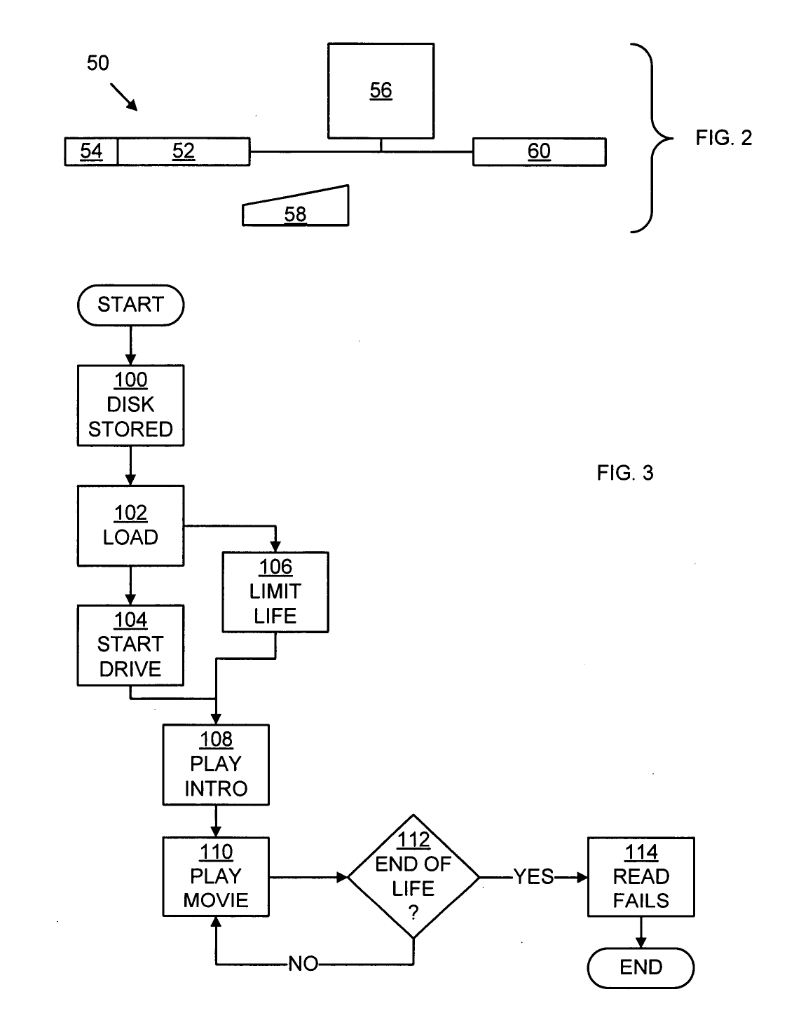

Referring now to FIG. 2, one form of DVD playing system, indicated generally by the reference numeral 50, comprises a DVD player 52 including a disc drive 54 arranged to read CDs, DVDs, or other discs of the same format as the disc 10 shown in FIG. 1, a display 56, which may be a television set connected to receive signals from the DVD player 52, and a control unit 58, which may comprise one or more remote controls and/or controls mounted on the DVD player 52, the television set 56, and/or one or more devices contributing to the system 50. The system 50 may also include other devices 60, which may include other sources of material to be displayed on the television set 56.

Referring now to FIG. 3, in step 100, a disc 16 in the form of a pre-recorded DVD is provided. As long as no attempt is made to read the disc 10, the life-limiting agent does not become active, and the disc 10 may be shipped, stored, and handled as desired.

In step 102 the user places the disc in the disc drive 54. In step 104, the DVD player 52 starts up the disc drive 54, and reads at least initial information from the disc 10. A command to play the disc 10 may be issued by a user through the control unit 58. However, many commercially available DVD players automatically read a disc 10 as soon as the disc 10 is loaded into the disc drive 54.

In step 106, the limited operating life of the disc 10 starts. The exact point at which the process of self-destruction that limits the operating life starts depends on the mechanism of the life-limiting process, and the process for handling the disc. For example, where the life-limiting process is initiated by centrifugal or other forces generated during the reading of the disc, as described with reference to FIG. 1, and where the DVD player 52 is arranged automatically to read any new disc that is inserted into the disc drive 54, the disc is read, and self-destruction starts, at the beginning of step 104, immediately after step 102. Where the disc drive 54 does not automatically read every disc, the disc 10 may only be read, and self-destruction started, in response to the command given in step 104.

In step 108, the DVD player displays introductory material, which may include a warning to the user on the display 56, explaining that the disc has a limited life, and will cease to be viewable a specified time after the message first appears.

In step 110, the user views the motion picture or other material on the disc 10, exactly as the user would view an ordinary rented DVD, except that because the disc 10 is not repeatedly used by successive renters, the disc is less likely to be damaged.

In step 112, the end of the limited operating life is reached, a predetermined time after the limited operating life started in step 108, when part of the information on the disc 10 becomes unreadable by the action of the liquid chemical agent 42. In step 114, the DVD player 52 attempts to read the unreadable information, and fails. Where the unreadable information is the lead-in section 26 of a DVD, the reading typically fails when the DVD is loaded into the disc drive 54 and the DVD player 52 attempts to read the disc, or during playing when the DVD player 52 attempts to use the data on the lead-in section 26 to locate a new track.

Aluminum, which is a material widely used for the reflective layers of CD and DVD discs, has relatively low reactivity in that, due to its characteristics, it is protected by a cover of oxide at any time. Despite this low reactivity, aluminum is known to react to certain chemicals under certain conditions and circumstances when the aluminum oxide is dissolved by a chemical agent that can, because of the dissolution of the oxide, react with the aluminum. For example, aluminum is sensitive to bases such as NaOH or KOH, acids such as HCl, H₂SO₄, HNO₃, and citric acid, and several metallic salts, such as CUSO₄, NaCl, silver nitrate, and gold chloride, as a few examples. The same reagents may be used with silver as the reflective layer.

The properties of these chemical agents may be advantageously used to facilitate and control the rate of dissolution or corrosion of the aluminum. For example, the corrosion of an aluminum reflective layer 16 may be steady and uniform with certain agents, such as NaOH or HCl, or the layer may become pitted upon exposure to agents such as CuSO₄.

In particular, a solution of NaOH with a concentration of 0.06 g/l and a pH of 11 generates a rate of dissolution of the aluminum reflective layer 16 ranging anywhere between approximately 0.3 micron per hour and approximately 1.0 micron per hour. In a typical DVD, the thickness of the aluminum reflective layers is typically 40 or 50 nanometers. With the above-mentioned NaOH solution, therefore, an operating life of from 2½ to 10 minutes will result. If a longer operating life is desired, inhibitors like soda silicate can reduce or delay the action of NaOH, thereby reducing the rate of dissolution of the aluminum of the reflective layer 16, and extending the period over which the data will become unreadable. Alternatively, the operating life could be adjusted by changing the thickness of the aluminum layer and/or the concentration of the NaOH solution.

A solution of HCl with a concentration of 5.0% produces a rate of dissolution of the aluminum of the reflective layer 16 ranging anywhere between approximately 1.0 microns per 24 hours and approximately 3.0 microns per 24 hours, giving an operating life of around 20 minutes to 1 hour without special thickening of the aluminum layer. Inhibitors can reduce or delay the effects of the HCl even further, thereby reducing the rate of dissolution, and extending the period over which the data will be readable.

As yet another example, a solution of CuSO₄ with a concentration of 1.0% produces a rate of dissolution of the aluminum of the reflective layer 16 ranging anywhere between approximately 1.0 microns per 24 hours and approximately 2.0 microns per 24 hours.

With the above-mentioned reagent solutions, therefore, a reasonable operating life for a DVD of from several hours to a few days will require either that the lead-in portion 26 of the first reflective layer 16 be specially thickened over the typical 40 or 50 nanometers, or that a weaker solution of the reagent be used.

Alternatively, a mixture of one part saturated citric acid in water, two parts saturated NaCl in water, and twenty parts aqueous carrier medium disables a typical aluminum reflective layer in a DVD in between 8 and 24 hours at room temperature.

Care should be taken that the liquid chemical agent 42 does not dissolve the polycarbonate or other material of the substrates 14 and 22, and does not dissolve the adhesive 18. Even if the disc 10 is kept for a long period after it ceases to be usable, the liquid 42 is unlikely to dissolve out along the layers of reflective material 16 and 20 and escape at the edge of the disc, because of the narrowness of the gap that would be formed by such dissolution. The liquid 42 should, however, not be such a strong corrosive agent that it would create a hazard to persons or property if the liquid were released by breaking the disc 10.

Another factor is the type of metallic material used for the reflective layer 16. Although aluminum is presently widely used, other types of metallic material having properties similar to aluminum may be used with the optical storage medium 10. Therefore, the type of metallic material used for the reflective layer 16 should be taken into account to determine the type, concentration, and amount of the chemical agent 42 needed. The same reagents mentioned above may be used in approximately the same concentrations with silver as the reflective layer. A solution of 1% NaCl and 1% CuSO₄ can give an operating life of approximately 5 minutes in a disc 10 where the reflective layer is silver; and a solution of from 1% to 15% KCl can give an operating life of approximately 5 minutes in a disc 10 where the reflective layer is silver. The KCl composition used with a silver disc is presently preferred, with an appropriate concentration of KCl chosen to give a desired operating life.

In the present embodiment, the liquid chemical agent 42 is formulated using an aqueous carrier medium that comprises propylene glycol, also known as propan-1,2-diol, formula CH₂OH.CHOH.CH₃, as well as water.

Under conditions including an atmosphere with very low humidity, a polycarbonate disc 10 with a liquid chemical agent 42 in which the carrier medium is pure water can lose so much water by evaporation through the disc that the limited-life feature can become ineffective in as little as 30 days. That minimum life can be increased by additional coatings inside the cavities or on the outside of the disc to reduce permeability to water, and/or by suitable packaging. However, additional coatings increase the cost and complexity of the disc, and packaging increases the cost and bulk.

The addition of glycol inhibits the loss of water under dry conditions very simply. In addition, the glycol can actually attract water from the atmosphere under moist conditions, and so can dynamically stabilize the amount of water in the carrier medium of the agent 42 under conditions of fluctuating external humidity. The stabilizing effect is strengthened because any reduction in the water content increases the amount of unsaturated glycol, and thus the effective affinity of the glycol for water, and vice versa, so that the glycol has a buffering action. Further, even when the water content of the carrier medium is low, the glycol itself is liquid, and can act as the liquid carrier medium. The minimum required amount of water is typically only enough to maintain the active acid, alkali, or salt in the liquid chemical agent in solution in ionized form.

It has been found that propylene glycol can effectively retain up to half its volume in water. A mixture of 2:1 by volume propylene glycol to water is therefore possible. However, a mixture comprising approximately 80% propylene glycol and 20% water at the time when the agent is injected into the disc is presently preferred. Under typical storage conditions, the water content then fluctuates depending on the ambient humidity, with the total liquid volume within the first reservoir 30 typically varying within ±10% of its initial value.

In addition, glycol is known to act as an antifreeze, which reduces the risk of the water in the agent 42 freezing under cold conditions. As is known, water expands when it freezes to ice, and in spite of the liquid agent 40 occupying only about half of the first reservoir 30, with the remainder of the first reservoir empty, the possibility cannot be excluded that freezing could result in distortion or damage to the disc 10.

Other liquids that can be used include ethylene glycol, which is technically satisfactory, but may not be preferred commercially because of its greater toxicity, glycerin, various glycerols, and some liquid silicones.

Because the liquid chemical agent 42 is retained in the first reservoir 30 solely by capillary action, the surface tension of the liquid and the readiness with which that liquid wets the material forming the first reservoir and the second reservoir 36 are important. It has been found that with a water-based liquid 42 that does not contain any additives materially altering the surface tension or wetting properties, and polycarbonate substrates 14 and 22, a first reservoir from 0.03 mm to 0.4 mm deep in the axial direction is suitable. A depth of 0.25 mm is presently preferred. In the embodiment shown in the drawings, the radial width of the first reservoir 30 is 3.5 mm. Because of the large difference between the width and the depth, only the depth is important. If the reservoir 30 is too shallow, then the liquid 42 will not reliably be forced to flow by the centrifugal force at the normal operating speed of a CD or DVD. If the reservoir 30 is too deep, then the liquid 42 may flow out too easily before the disc 10 is used.

Other liquids may require different dimensions for the reservoirs 30 and 36. For example, a liquid that wets the substrates more readily than water may require a shallower reservoir. For glycol and water mixtures, the capillarity (measured as the height to which the liquid will climb in a glass tube under standardized conditions) is weaker than for pure water, with pure propylene glycol having only about ⅔ of the capillarity of pure water, and a mixture of 80% propylene glycol to 20% water having about 71% of the capillarity of pure water. Also, if an ink is added to make the liquid 42 visible, and thus make it easier to see if the liquid has been expelled into the second reservoir, it should be borne in mind that many inks contain a surface active agent that may affect the behavior of the liquid. Testing the capillary behavior of a specific liquid in a specific medium, such as polycarbonate, and adjusting the designed depth of the reservoirs 30 and 36 is merely routine.

While it is not necessary for the liquid 42 to spread over the entire periphery of the second reservoir 36, it is desirable for the liquid to spread freely. Because the second reservoir 36 is bounded partly by the aluminum or other reflective material of the lead-in section 26, the behavior of the liquid 42 may be different in the first and second reservoirs. The water-based liquids mentioned above, including water and glycol mixtures, are particularly suitable in the present embodiments, because they wet aluminum and silver more readily than they wet polycarbonate, so they flow more freely in the second reservoir 36 than in the first reservoir 30.

Various modifications and variations can be made in the present invention without departing from the spirit or scope of the invention.

For example, the disc shown in FIG. 1 may be substantially the same as the disc shown and described in U.S. Patent Application Publication No. 2005/0195728. Alternatively, other forms of self-destructing storage medium, including forms already known in the art and forms hereafter to be developed, may be used, provided that the self-destruction process involves the use of a liquid for which the mixture of water and a hygroscopic substance can be applied.

The embodiments of the invention described above with reference to the drawings relate primarily to the distribution of motion pictures and other entertainment media for use by members of the public over a limited period of time. However, the invention has applicability for other situations where a storage medium that remains readable for only a limited period after activation is desired. For example, if the disc 10 is used to distribute computer programs or other information that is to be installed from the disc 10 onto a computer or the like, a life of from a few minutes to a few tens of minutes after the disc is first activated may be sufficient to allow installation on one computer, while frustrating attempts to install on multiple computers.

Although the destruction of the lead-in section of a CD-ROM or DVD disc provides a simple and effective embodiment of the invention, other parts of the information on a storage medium could be destroyed, depending in part on the arrangement of the specific storage medium. For example, any part of the information on the medium could be destroyed, provided the destruction of that information is effective to render the medium unusable to the ordinary user. The information need not actually be destroyed, but could alternatively be obscured or obliterated so that the information cannot be reliably read by generally available playback devices. Alternatively, the medium could be constructed so that only part of the information on the disc becomes unusable.

Although the present specification refers to the disc 10 or other storage medium becoming unusable after a predetermined time, it is not usually necessary for the operating life of the medium to be very precisely predetermined. For consumer protection purposes, it is desirable to be able to specify a minimum operating life, defined so that a disc 10 becoming unusable in less than the minimum operating life would be regarded as defective. For the benefit of the owner of the copyright in the motion picture or other information stored on the disc 10, who wishes to be sure that the purchaser receives only the benefit that the purchaser has paid for, it is desirable to be able to specify a maximum operating life, defined so that a disc 10 remaining usable for more than the maximum operating life would be regarded as defective. However, in many commercial models the maximum operating life may acceptably be several times the minimum operating life. In particular, as noted above, the water to glycol ratio in the disc 10 may vary depending on ambient conditions. Where the potency of the acid, alkali, or salt solution in the liquid agent 42 depends on the water content of the agent 42 affecting the degree of ionization of the active ingredient, the operating life of the disc may depend on the weather. The disc may then have a typical or nominal operating life that is somewhere between the minimum and the maximum, and any of those measures of the operating life of the disc may be regarded as a “predetermined” life.

Although the described embodiment involves a disc 10 in which the information content is molded onto the substrate layers, a writable disc 10 on which information is “burned” after the disc is assembled is possible. A writable disc either would have a comparatively long operating life that starts when the disc is burned, or would be charged with the liquid chemical agent 42 after burning is completed.

The novel features disclosed in the present application may be combined with the features disclosed in my co-pending U.S. Patent Application No. 60/860,615 filed Nov. 22, 2006, and U.S. Patent Application No. 60/860,553 filed Nov. 22, 2006.

For example, in the above embodiment the agent 42 is described as a liquid. However, as explained in more detail in U.S. Patent Application No. 60/860,553 filed Nov. 22, 2006, the agent may take other forms, including a thixotropic gel or a soft, waxy solid, especially when the unbalanced construction described in that application is used.

Thus, it is intended that the present invention cover the modifications and variations of this invention provided they come within the scope of the appended claims and their equivalents.

What is claimed is:

1. A limited-life storage medium comprising a flowable agent, wherein the flowable agent comprises water and a hygroscopic substance.

2. A limited-life storage medium according to claim 1 that is arranged to be moved during reading, and wherein the flowable agent is arranged to move relative to the storage medium in response to the movement of the storage medium during reading to a position in which the flowable agent initiates a process limiting the operating life of the storage medium.

3. A limited-life storage medium according to claim 2 that is a disc, and wherein the flowable agent is arranged to move by centrifugal force in response to rotation of the disc during reading.

4. A limited-life storage medium according to claim 1 that comprises a metallic data-carrying element soluble in the flowable agent.

5. A limited-life storage medium according to claim 1 wherein the hygroscopic substance is flowable.

6. A limited-life storage medium according to claim 1 wherein the hygroscopic substance comprises at least one substance selected from the group consisting of ethylene glycol, propylene glycol, other glycols, glycerin, glycerols, silicones, and mixtures thereof.

7. A limited-life storage medium according to claim 6 wherein the hygroscopic substance comprises propan-1,2-diol.

8. A limited-life storage medium according to claim 7 wherein the flowable agent consists essentially of propan-1,2-diol, water, and at least one water-soluble reagent that in operation reacts with a data-carrying component of the medium so as to render at least a part of the data-carrying component unusable after a predetermined time.

9. A limited life storage medium according to claim 8, wherein the ratio of propan-1,2-diol to water is at least 1:1 by volume.

10. A limited life storage medium according to claim 9, wherein the ratio of propan-1,2-diol to water is at least 2:1 by volume.

11. A limited life storage medium according to claim 10, wherein the ratio of propan-1,2-diol to water is at least 3:1 by volume.

12. A limited life storage medium according to claim 8, wherein the at least one water-soluble reagent is selected from NaOH, KOH, HCl, H₂SO₄, HNO₃, citric acid, CUSO₄, NaCl, AgNO₃, AuCl₃, and combinations thereof.

13. A limited life storage medium according to claim 1, wherein the hygroscopic substance is selected to buffer the amount of water.

14. A limited life storage medium according to claim 13, wherein the hygroscopic substance is selected to buffer the amount of water within a range at which the medium remains flowable through normal variations in the humidity of the ambient atmosphere.
